(19) United States
(12) Patent Application Publication
(10) Pub. No.: US 2024/0202419 A1
(43) Pub. Date: Jun. 20, 2024

(54) AI TECHNOLOGY TO DETERMINE THE CEILING THERMAL PERFORMANCE OF A SYSTEM ON CHIP FLOORPLAN

(71) Applicant: Intel Corporation, Santa Clara, CA (US)

(72) Inventors: Miaomiao Ma, Sunnyvale, CA (US); Adam Norman, Forest Grove, OR (US); Jianfang Olena Zhu, Portland, OR (US); Mackenzie Norman, Portland, OR (US); Mark Gallina, Hillsboro, OR (US); Pei Chun Ch'ng, Penang (MY); Xia Zhu, Portland, OR (US); Jagadeesh Radhakrishnan, Folsom, CA (US); Soon Khiang Toh, PENANG (MY); Omer Vikinski, Haifa (IS); Slade Morgan, Forest Grove, OR (US)

(21) Appl. No.: 18/538,409

(22) Filed: Dec. 13, 2023

(51) Int. Cl. G06F 30/392; G06F 30/27; G06F 115/02; G06F 119/08

(52) U.S. Cl. CPC G06F 30/392; G06F 30/27; G06F 2115/02; G06F 2119/08

(57) ABSTRACT

Systems, apparatuses and methods may provide for technology that determines a plurality of transient thermal responses for a corresponding plurality of power source locations on a semiconductor die, obtains corner block list (CBL) representations associated with a plurality of candidate floorplans, and conducts an artificial intelligence (AI) based search of the CBL representations, wherein an output of the AI based search is one or more suggested floorplans having a transient thermal response that is below a thermal threshold.

### BACKGROUND

In the design of semiconductor packages, Buried Power Rails (BPRs) and Backside Power Delivery (BSPD) technology has been adopted for further scaling enablement. With BPR and BSPD technologies, a system on chip (SoC) may be coupled to a front side of a substrate and a power delivery network may be coupled to a back side of the substrate, with power rails being buried into the substrate. Such an approach frees up routing resources for power/ground supply networks (“nets”) in both standard cells and block designs. Additionally, BPR has a direct power supply from the package interconnect (e.g., bump contacts) and a lower resistance than regular back end of line (BEOL) rails in older technology. This approach may improve current-resistance (IR) drop significantly and provide better power, performance, and arca (PPA) results.

A challenge of BPR, however, is thermal performance management. In older technologies, a heatsink can directly connect to the bulk of the silicon substrate, which provides an efficient transfer of transistor generated heat to the heatsink. With BPR technology, however, the silicon substrate is sandwiched between front side and back side metal stacks. Since the substrate is moved farther away from the heatsink, a negative impact on thermal performance may be encountered.

### BRIEF DESCRIPTION OF THE DRAWINGS

The various advantages of the embodiments will become apparent to one skilled in the art by reading the following specification and appended claims, and by referencing the following drawings, in which:

FIG. 1A is a comparative illustration of an example of a conventional floorplan heat map and an enhanced floorplan heat map according to an embodiment;

FIG. 1B is an illustration of an example of an enhanced floorplan heat map according to another embodiment;

FIG. 2 is an illustration of an example of superposition source simulations according to an embodiment;

FIG. 3 is an illustration of an example of an enhanced floorplan heat map with dummy blocks according to an embodiment;

FIG. 4 is a block diagram of an example of a process flow to handle physical connectivity constraints according to an embodiment;

FIG. 5 is a block diagram of an example of a process flow involving the use of a thermal response tool according to an embodiment;

FIG. 6 is a flowchart of an example of a method of generating system on chip (SoC) floorplans according to an embodiment;

FIG. 7 is a flowchart of an example of a method of managing corner block list (CBL) representations according to an embodiment;

FIG. 8 is a block diagram of an example of a performance-enhanced computing system according to an embodiment;

FIG. 9 is an illustration of an example of a semiconductor package apparatus according to an embodiment;

FIG. 10 is a block diagram of an example of a processor according to an embodiment; and

FIG. 11 is a block diagram of an example of a multi-processor based computing system according to an embodiment.

### DETAILED DESCRIPTION

Managing the temperature of a processor chip can affect both the performance and the reliability of the chip. System thermal architects may typically spend several weeks to obtain the lowest ceiling temperature by considering different SoC (system on chip) floorplans. Since there is no commercial software that can automate this thermal performance optimization process, thermal architects may manually study all known combinations. Moreover, it is often not clear whether a lower temperature (e.g., therefore better performance) is even achievable for a given floorplan.

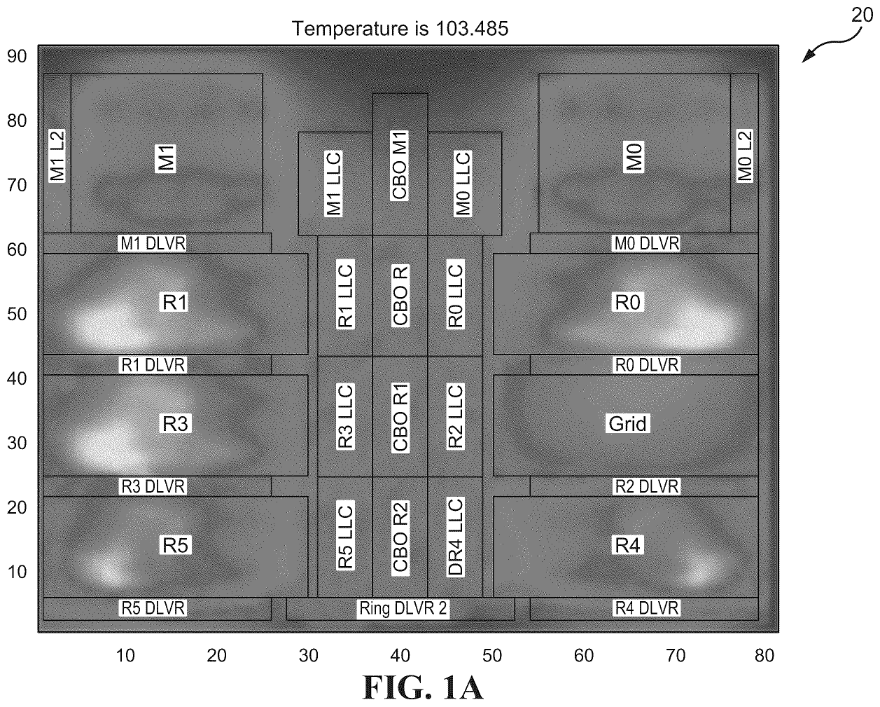

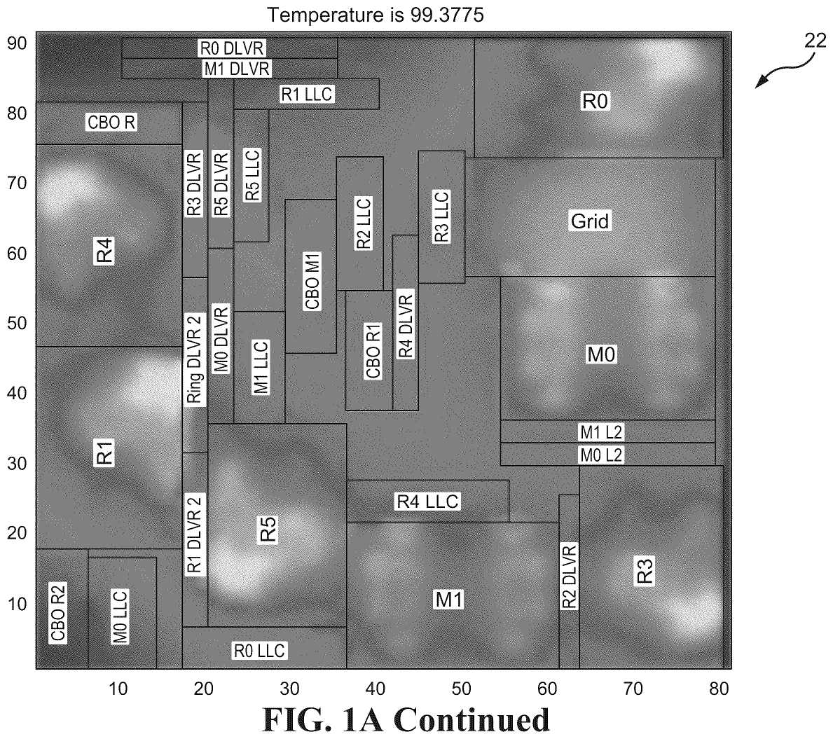

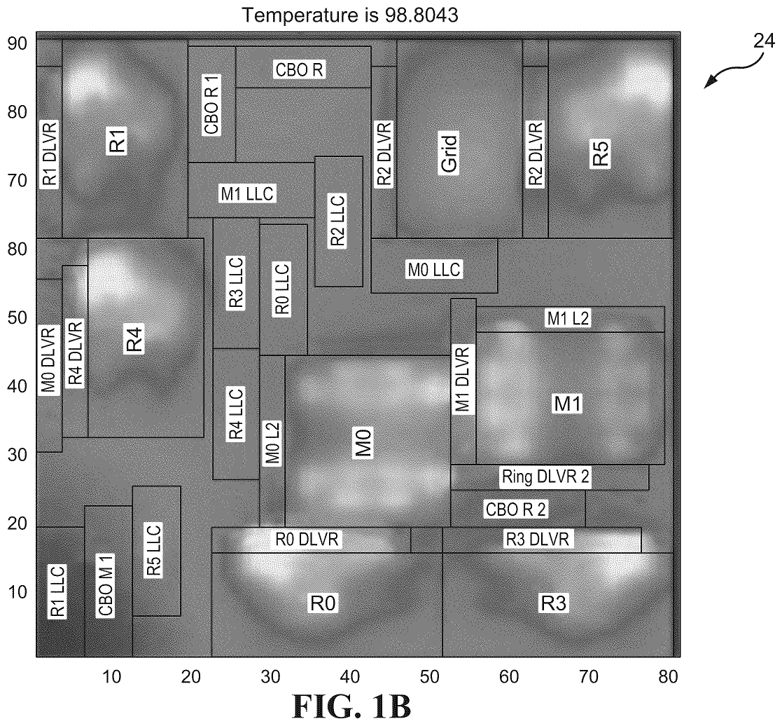

FIG. 1A shows a heat map for a conventional SoC floorplan 20. In the illustrated example, there are thirty-one functional blocks including six high-performance cores (e.g., tightly spaced cores “R0” through “R5”, with R2 being designated as a “Grid” for detailed analysis), two high-efficiency cores (e.g., cores “M0” and “M1”), eight last level caches (LLCs), two level two (L2) caches, nine digital linear voltage regulators (DLVRs) and eight CBOs (cache boxes, e.g., cache coherency and LLC controller in a converged coherent fabric/CCF). The heat map of the floorplan 20 results in a predicted maximum temperature of 103.485º Celsius (C) during operation.

The conventional SoC floorplan 20 represents traditional manual placement, where the various functional (e.g., intellectual property/IP) blocks are arranged in a very organized/uniform manner. Although the uniform placement may facilitate manual verification of various signal timing and routing constraints between IP blocks, such an approach causes duplicated copies of the same block (e.g., central processing unit/CPU cores) to cluster together. Since these blocks typically consume the highest power, the conventional SoC floorplan 20 results in relatively a high operating temperature due to the proximity of the cores to one another. The power concentration caused by clustering results in poor thermal conductivity of the system cooling solution and ultimately reduces the total power that the SoC can dissipate.

By contrast, an enhanced SoC floorplan 22 demonstrates that the technology described herein can optimize the thermal performance of the conventional SoC floorplan 20. More particularly, by optimizing the functional block layouts and power map inside each block, it is possible to lower the maximum temperature, which improves chip performance and reliability. In the illustrated example, the enhanced SoC floorplan 22 is non-uniform and the predicted maximum temperature during operation is reduced from the initial 103.485° C. to 99.3775° C. without considering any physical connectivity constraints between the blocks.

FIG. 1B shows a heat map for another enhanced SoC floorplan 24 for which physical connectivity constraints between the functional blocks (e.g., DLVR attached to R, L2 cache attached to M) were considered. In the illustrated example, the predicted maximum temperature during operation was reduced to 98.8043° C. For this specific floorplan 24 with one workload, the technology described herein achieves about a 4˜5° C. temperature drop. In most instances, a 3° C. drop is sufficient to shift the design decision. Embodiments may also be used to achieve greater than a 3° C. temperature drop for all test cases. Indeed, the floorplan 24 may be selected from a plurality of floorplans that all provide improved thermal performance due to the technology described herein. Moreover, the total execution time of the technology described herein is significantly faster (e.g., about 4 hours) than the manual approach associated with the conventional SoC floorplan 20 (FIG. 1A).

With the end of Dennard Scaling (e.g., stating that, as transistors reduce in size, their power density stays constant), but with the continued pursuit of advanced lithography nodes, semiconductor temperature response and local heat spreading have become more relevant and higher priority in chip design. Certain computing products may include performance cores (e.g., highest power density blocks) placed near the center of the die. Such a layout still results in some clustering of similar IP blocks (e.g., compute cores), but the cores are located near the center of the die (e.g., with the non-compute IP such as input/output (IO), system agents, and register blocks surrounding the cores). These lower power regions may enable the heat from the cores to dissipate and spread with lower temperature gradients.

Other computing products resulting from a manual layout process result in an aspect ratio of the entire chip that is based on the linear progression of functional block placement, and the layout has rigid uniformity. In direct contrast to other layouts, the cores are not only clustered together, but positioned along the edge of the die, with the IO, system agent, and register blocks on the far side of the die. In this configuration, the center CPU cores tend to be the thermal limiters because the heat generated by the center CPU cores is trapped within the floorplan. Such configurations have cores on both sides of the substrate, which also generate heat, and the edges of the die prevent heat conduction in that direction.

The enhanced SoC floorplans 22, 24 (FIGS. 1A, 1B) can be achieved through an AI-based method for more efficient SoC floorplanning and improved thermal performance. Several optimization procedures from computational intelligence techniques, a subset of artificial intelligence, are adapted and customized for this thermal SoC floorplan optimization problem. In addition, the tool and/or technology described herein can generate many floorplans with acceptable thermal performance for users to choose from during optimization. Embodiments can be used at different length scales, from SoC core layouts to system IP blocks.

Advantages of the technology described herein include faster thermal response evaluation of arbitrary floorplans, simultaneous optimization of the entire SoC floorplan and power map in each block, the ability to provide lower bound SoC thermal performance and more floorplan options, and increased engineering efficiency (e.g., time reduced from weeks to hours).

The technology described herein prevents CPU cores from being clustered with rigid uniformity (e.g., enhancing performance). Indeed, factoring thermal performance (e.g., rather than merely power performance) into the SoC design is a significant advancement over conventional approaches.

System thermal architects can use the technology described herein to understand the maximum thermal performance for any SoC floorplan. Such an approach can ensure that manual optimization is ended when a low enough temperature is achieved, while considering all physical design constraints. Embodiments can speed up optimization of SoC floorplans on thermal performance from weeks to within one day, while providing an optimal thermal solution. With a better thermal SoC, chip products have better performance and are more reliable. The automated technology described herein enables more complex floorplan options to be considered and expedites the design process of intricate SoCs by inherently incorporating accurate thermal consideration into the process.

As already noted, the AI-based technology described herein quickly evaluates thermal responses and identifies the lowest temperature bound with or without any constraints in the SoC floorplan. Accordingly, thermal architects are able to determine the ceiling thermal performance that can be achieved and discontinue optimization efforts when a low enough temperature is achieved while taking into account all physical design constraints. Such an approach speeds up the development of SoC floorplans on thermal performance, saving time and resources.

Embodiments include the use of a fast-evaluating thermal response tool (e.g., INTEL SUPERGRID). The thermal response tool facilitates the evaluation of a higher volume of floorplans and workloads. The thermal response tool builds a physics-based machine-learning model for thermal analysis. The SoC thermal performance is usually linear and time invariant since the material is the same. Thus, the principle of superposition (e.g., stating that, for all linear systems, the net response caused by two or more stimuli is the sum of the responses that would have been caused by each stimulus individually) holds. Exploiting the superposition principle, however, may be difficult to achieve under conventional approaches due to numerical issues with many superposition sources.

In one example, the applicability of superposition can be examined with a thermal analysis tool such as, for example, the INTEL DOCEA tool. Such an analysis tool has demonstrated that the numerical issues have been resolved and a superposition approach can be effectively used for use cases of interest. The speed-up in analysis time is significant (e.g., more than 50,000 times faster), which can enable the relevant analysis flows. Additionally, this reduction in latency was achieved without any loss in accuracy, and without approximation.

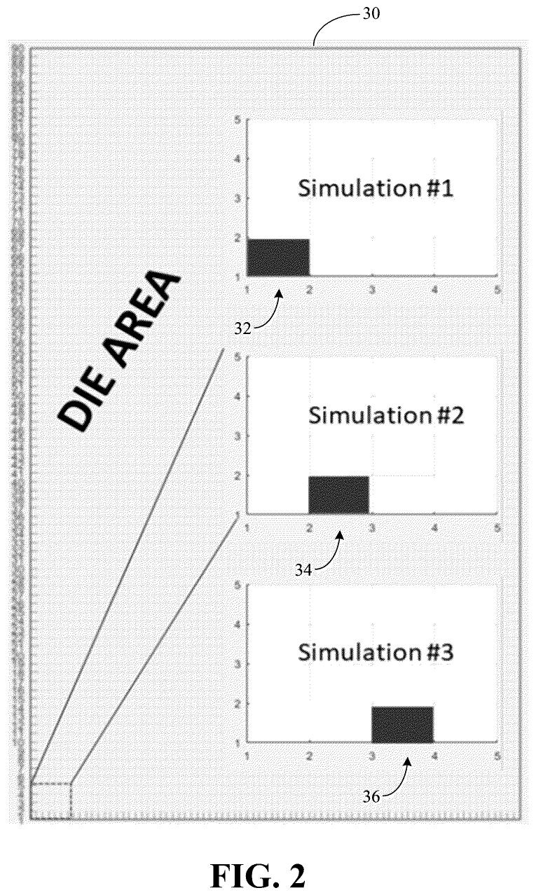

Turning now to FIG. 2, the thermal response tool divides the die area 30 into a grid with superposition sources 32, 34, 36. Although three superposition sources 32, 34, 36 are shown, the total number of superposition sources 32, 34, 36 is the same as the number of grid cells. This approach facilitates not only the application of the superposition principle, but also the creation of any possible floorplan suitable for the die area 30 of the chip. More particularly, the thermal response tool creates a grid of superposition sources 32, 34, 36 for the die of interest and runs a thermal step response for each cell in the grid plus any non-grid sources (e.g., applying 1 Watt (W) and measuring the thermal response across the die for X time steps). Then, the thermal response tool applies the principle of superposition to find the transient thermal response for any possible floorplan and power map. The determination of the transient thermal response can be repeated for any additional floorplan and power map as shown in FIG. 2. In the illustrated example, only the first three of 7200 source cells are shown for an 8 millimeter (mm) by 9 mm die gridded at 100 micrometers (μm) by 100 μm.

The fast-evaluating thermal response from the thermal response tool significantly enhances the optimization of SoC floorplans for thermal performance. Then an AI-based methodology can be used to find the best floorplan and power map rotation with minimal thermal temperature. In an embodiment, this methodology involves a two-level optimization:
Use an optimization procedure with CBL (Corner Block List) representations to find a new floorplan fit into an SoC area.
Use a genetic procedure to optimize the power map of each functional block to determine the minimal temperature. A corner block list is a mathematical representation of a floorplan, which is an effective method in the field of very large-scale integration (VLSI) design. Different AI based searches, such as, for example, simulated annealing, reinforcement learning, etc., may be used to identify floorplans based on CBL representations. These procedures are equally applicable for finding the global optimum. For example, simulated annealing operations conduct a heuristic search method of artificial intelligence, and accept worse solutions with a certain probability to introduce randomness. This approach helps in escaping local minima. In reinforcement learning operations, agents can use exploration policies (e.g., “epsilon-greedy”) that introduce randomness to encourage the exploration of different actions. Moreover, CBL may be customized with two new advancements for thermal analysis.

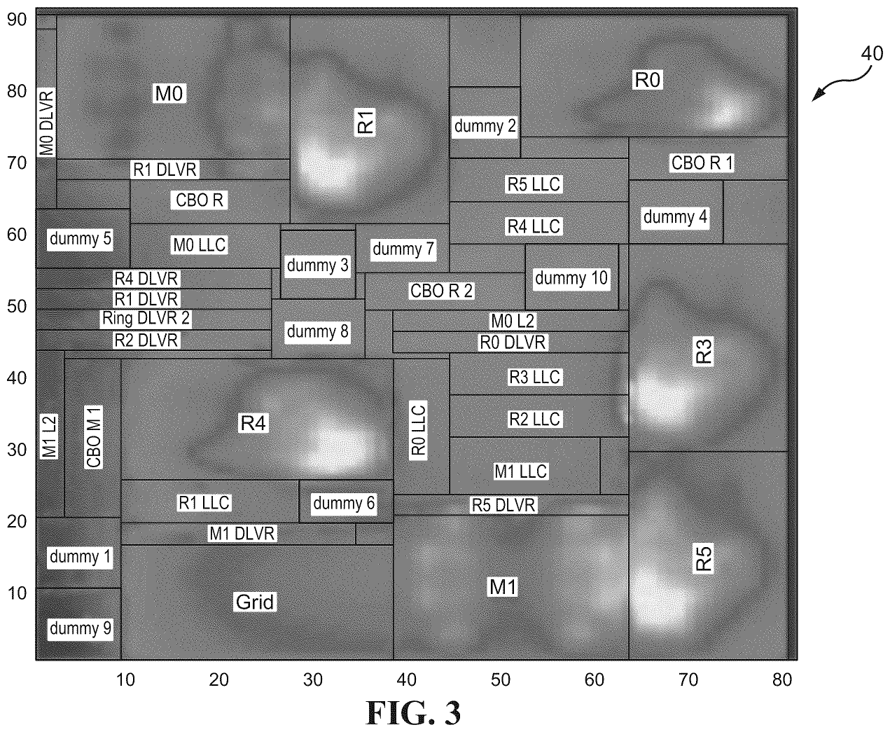

Turning now to FIG. 3, the first advancement is to insert extra “dummy” blocks to the CBL representations to create extra space. The extra space separates the hot spots between the cores, which in turn lowers the maximum temperature. More particularly, a heat map of a floorplan 40 is shown in which dummy blocks (“dummy 1” to “dummy 10”) are inserted into the CBL representations. The illustrated solution leverages the fact that separating core hot spots would generally result in better chip thermal performance. For example, the hot spots R1 and R0 are further separated by dummy block 2. The sizes and number of dummy blocks may be determined by how much empty space is available for each SoC design.

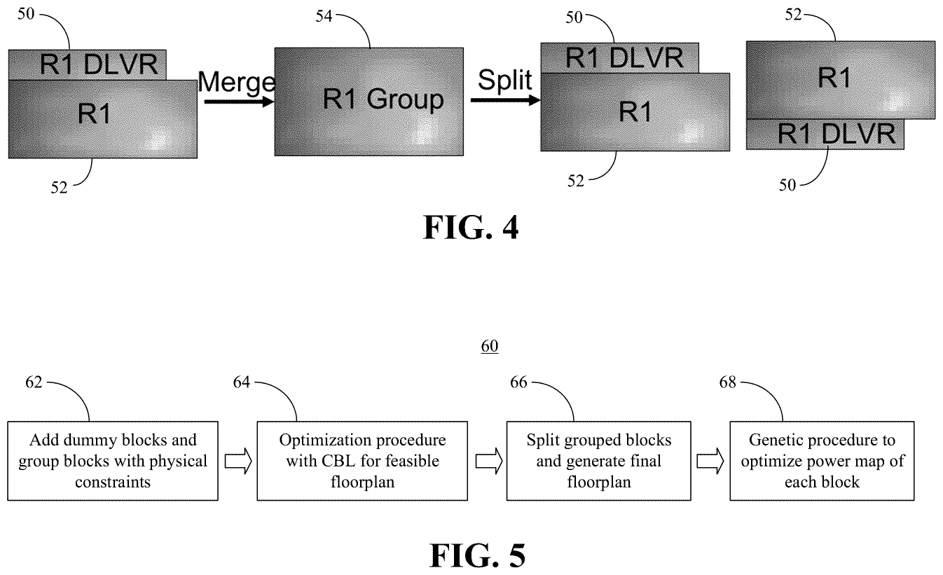

Turning now to FIG. 4, the second advancement is to handle physical connectivity constraints of the functional blocks within the CBL framework. In general, a hierarchical design process starts by identifying a plurality of blocks 50, 52 having a physical connectivity constraint and combining/merging the plurality of blocks 50, 52 into a group 54. For example, a first block 50 can include a DLVR that is to be placed connected/adjacent to a second block 52 that includes an R1 core. Accordingly, the plurality of blocks 50, 52 are merged into a larger block called the “R1 Group”. After the AI based search (e.g., including simulated annealing, reinforcement learning operations and/or rotation analysis) of the CBL representations generates a feasible floorplan, the group 54 is split back into the original blocks 50, 52 for thermal performance calculation. As will be discussed in greater detail, the thermal performance calculation may include a symmetry analysis. The illustrated example demonstrates a symmetry analysis that examines the thermal effects of repositioning the blocks 50, 52 about the horizontal axis of the former group 54 (e.g., while maintaining physical connectivity/proximity).

Turning now to FIG. 5, a process flow 60 is shown, where a thermal response tool is used for fast thermal response during optimization. A first operation 62 prepares the blocks to be fit into the chip area by adding dummy blocks and grouping blocks with connectivity constraints. The size and number of dummy blocks are determined by the remaining empty spaces of the design die. The dummy blocks may have similar areas as the medium size of all the available blocks on the SoC. If there is no space left, the addition of dummy blocks can be bypassed. When proximity design constraints (e.g., DLVR block attaches to its corresponding core block) in the SoC design are available, a group is formed for the blocks. This approach benefits realistic design requirements. A second operation 64 uses the optimization procedure with CBL to generate a new feasible floorplan to fit into the die area. In one example, simulated annealing is used as the optimization procedure with CBL. In another example, reinforcement learning is used to generate feasible floorplans. For each new floorplan, a third operation 66 splits the grouped blocks into the original blocks for a fourth operation 68 that involves power map optimization (e.g., based on symmetry analysis).

Since the dummy blocks have a power consumption of zero, the dummy blocks are not used in the thermal performance calculation. The genetic procedure is used to optimize the power map so that the maximum temperature could potentially drop to lower than current best solution. There are eight degrees of freedom in power map optimization for each block—four from rotation and four from symmetry. The total optimization solution space for genetic algorithm is therefore N8, where N is the number of blocks for each SoC floorplan. This solution space is 8.5×10¹¹ for the 31-block example of the conventional SoC floorplan 20 (FIG. 1A), already discussed. A programmable maximum number of iterations (e.g., 30000 is by default) may be set for the genetic procedure. When the iteration number of the genetic procedure exceeds the user-defined number, the optimization loop can be exited. The technology described herein outputs the final floorplan with ceiling thermal performance for user review within a user-defined maximum iterations. Meanwhile, several solutions may be output during the optimization process for user choice and edification.

As already noted, embodiments can be used at different length scales, from core block to SoC IP blocks and to system IP blocks. Each IP block in a SoC may be generally treated as an immutable object. The same type of analysis, however, can be performed on the core layout itself to improve the core block individually. Such an approach provides further opportunities to improve the thermal performance of the SoC.

In one example, the process flow 60 represents a SUPERGRID for fast thermal response solution. SUPERGRID uses a superposition approach in which a set of simulations are performed to “characterize” the SoC, from which any arbitrary floormap/workload can be rapidly solved. More particularly, the SoC can be broken into a grid of N sources, wherein the initial characterization simulations are run by exciting each source with 1 W and recording the thermal response across the entire response region. The thermal response is then simply calculated by summing the new power (Pₛ) at each of the sources, scaled by a superposition coefficient (Cₛ). This operation can be repeated for all x,y locations at every time step (t).

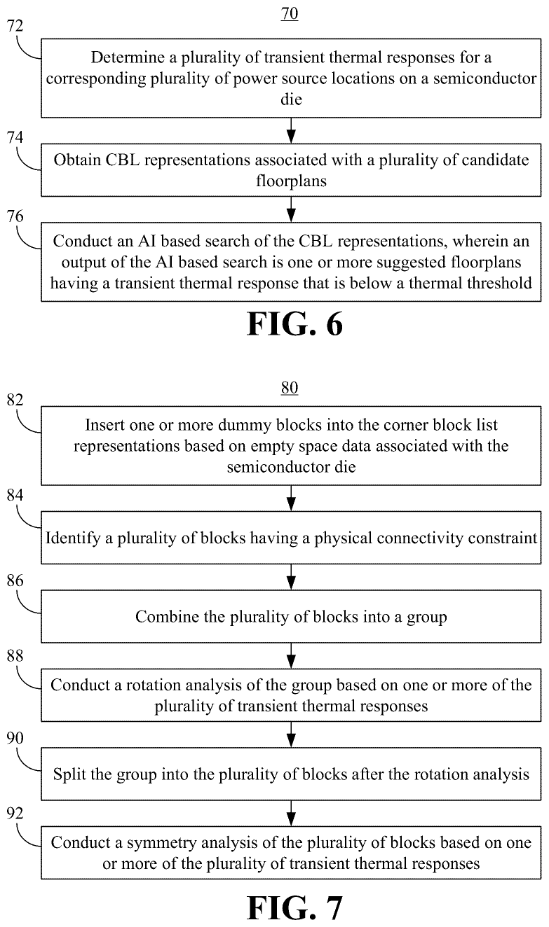

FIG. 6 shows a method 70 of generating SoC floorplans. The method 70 may may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 70 can be written in any combination of one or more programming languages, including an object oriented programming language such as JAVA, SMALLTALK, MATLAB, C++ or the like and conventional procedural programming languages, such as the “C” programming language or similar programming languages. Additionally, logic instructions might include assembler instructions, instruction set architecture (ISA) instructions, machine instructions, machine dependent instructions, micro-code, state-setting data, configuration data for integrated circuitry, state information that personalizes electronic circuitry and/or other structural components that are native to hardware (e.g., host processor, central processing unit/CPU, microcontroller, etc.).

Illustrated processing block 72 determines a plurality of transient thermal responses for a corresponding plurality of power source locations on a semiconductor die. In an embodiment, processing block 72 uses a thermal response tool to determine the plurality of transient thermal responses (e.g., via the application of 1 W of power and the measurement of the thermal response across the die for X time steps). Processing block 74 obtains CBL representations associated with a plurality of candidate floorplans. In general, a CBL representation is generated from a two-dimensional (2D) floorplan. In one example, a CBL is a data structure containing a three-valued tuple(S,L,T): block name, orientation and binary string for efficient topological representation of the floorplan. Processing block 76 conducts an AI based search of the CBL representations, wherein an output of the AI based search is one or more suggested floorplans having a transient thermal response that is below a thermal threshold (e.g., 100° C.). The AI based search may include one or more simulated annealing operations, one or more reinforcement learning operations, etc., or any combination thereof. The method 70 therefore enhances performance at least to the extent that the AI based search enables thermal performance to be considered during the SoC design phase (e.g., as opposed to after the SoC design is complete). Additionally, conducting the AI based search with respect to the CBL representations speeds up optimization of the SoC floorplan, improves the reliability of the selected floorplan and enable the consideration of more complex floorplan options.

FIG. 7 shows a method 80 of managing CBL representations. The method 80 may generally be incorporated into the method 70 (FIG. 6), already discussed. More particularly, the method 80 may be implemented in one or more modules as a set of logic instructions stored in a machine- or computer-readable storage medium such as RAM, ROM, PROM, firmware, flash memory, etc., in hardware, or any combination thereof.

Illustrated processing block 82 inserts one or more dummy blocks (e.g., dummy functional blocks) into the CBL representations based on empty space data associated with the semiconductor die. Processing block 84 identifies a plurality of blocks (e.g., functional blocks) having a physical connectivity constraint (e.g., the blocks are to be placed adjacent to one another). Processing block 86 combines the plurality of blocks into a group. In one example, processing blocks 84 and 86 are repeated for a plurality of groups. In an embodiment, processing block 88 conducts a rotation analysis of the group based on one or more of the plurality of transient thermal responses. For example, processing block 88 might use a genetic procedure (e.g., simulated annealing, reinforcement learning, etc.) to rotate each functional block and/or group in accordance with four degrees of freedom (e.g., 0° of rotation, 90° of rotation, 180° of rotation, 270° of rotation) and evaluate the thermal response at each angle of rotation. The rotation analysis may also include placement analysis (e.g., moving each functional block and/or group around the semiconductor die and evaluating the thermal response at each location).

Processing block 90 splits each group into the original plurality of functional blocks after the rotation analysis, wherein processing block 92 conducts a symmetry analysis of the plurality of functional blocks based on one or more of the plurality of transient thermal responses. In one example, the symmetry analysis is conducted in accordance with a genetic procedure (e.g., simulated annealing, reinforcement learning, etc.) and four degrees of freedom in which the functional blocks are placed on both sides of a horizontal axis and both sides of a vertical axis, with the thermal response being evaluated at each placement. The method 80 therefore further enhances performance at least to the extent that the groups, the rotation analysis and/or the symmetry analysis improve the reliability of the suggested floorplan(s).

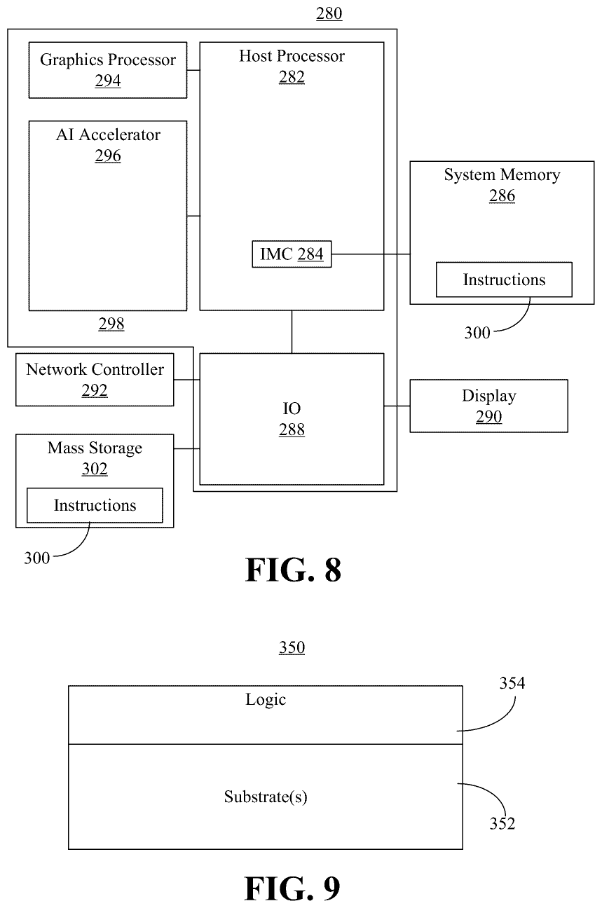

Turning now to FIG. 8, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IOT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an artificial intelligence (AI) accelerator 296 (e.g., specialized processor) into a system on chip (SoC) 298.

The host processor 282 and/or the AI accelerator 296 retrieves one or more executable program instructions 300 from the system memory 286 and/or the mass storage 302 and executes the instructions 300 to perform one or more aspects of the method 70 (FIG. 6) and/or the method 80 (FIG. 7), already discussed. Thus, execution of the instructions 300 causes the host processor 282, the AI accelerator 296 and/or the computing system 280 to determine a plurality of thermal responses (e.g., transient thermal responses) for a corresponding plurality of power source locations on a semiconductor die (e.g., to include Buried Power Rail (BPR) and/or Backside Power Delivery (BSPD) technology), obtain CBL representations associated with a plurality of candidate floorplans, and conduct an AI based search of the CBL representations, wherein an output of the AI based search is one or more suggested floorplans having a transient thermal response that is below a thermal threshold.

The computing system 280 is therefore considered performance-enhanced at least to the extent that the AI based search enables thermal performance to be considered during the SoC design phase (e.g., as opposed to after the SoC design is complete). Additionally, conducting the AI based search with respect to the CBL representations speeds up optimization of the SoC floorplan, improves the reliability of the selected floorplan and enable the consideration of more complex floorplan options. The instructions 300 further enhance performance to the extent that the groups, the rotation analysis and/or the symmetry analysis improve the reliability of the suggested floorplan(s).

FIG. 9 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 70 (FIG. 6) and/or the method 80 (FIG. 7), already discussed. Thus, the logic 354 determines a plurality of thermal responses (e.g., transient thermal responses) for a corresponding plurality of power source locations on a semiconductor die, obtains CBL representations associated with a plurality of candidate floorplans, and conducts an AI based search of the CBL representations, wherein an output of the AI based search is one or more suggested floorplans having a transient thermal response that is below a thermal threshold.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

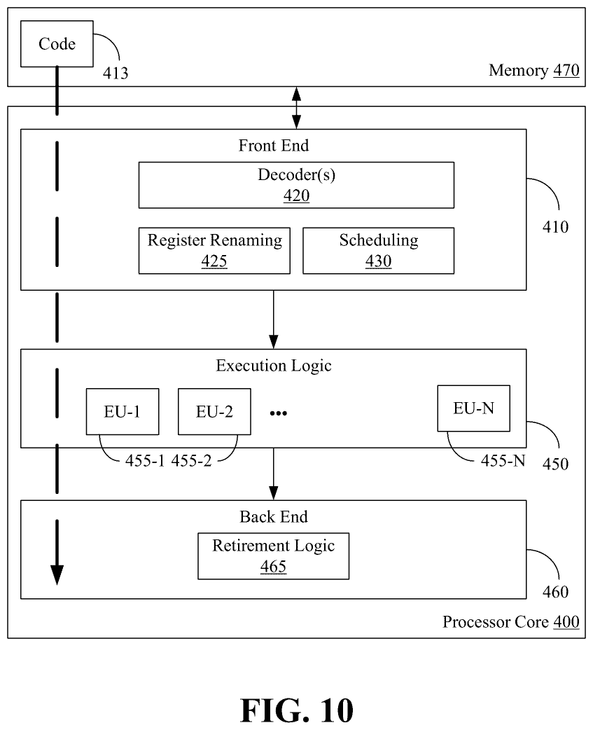

FIG. 10 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 10, a processing element may alternatively include more than one of the processor core 400 illustrated in FIG. 10. The processor core 400 may be a single-threaded core or, for at least one embodiment, the processor core 400 may be multithreaded in that it may include more than one hardware thread context (or “logical processor”) per core.

FIG. 10 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 70 (FIG. 6) and/or the method 80 (FIG. 7), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 10, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

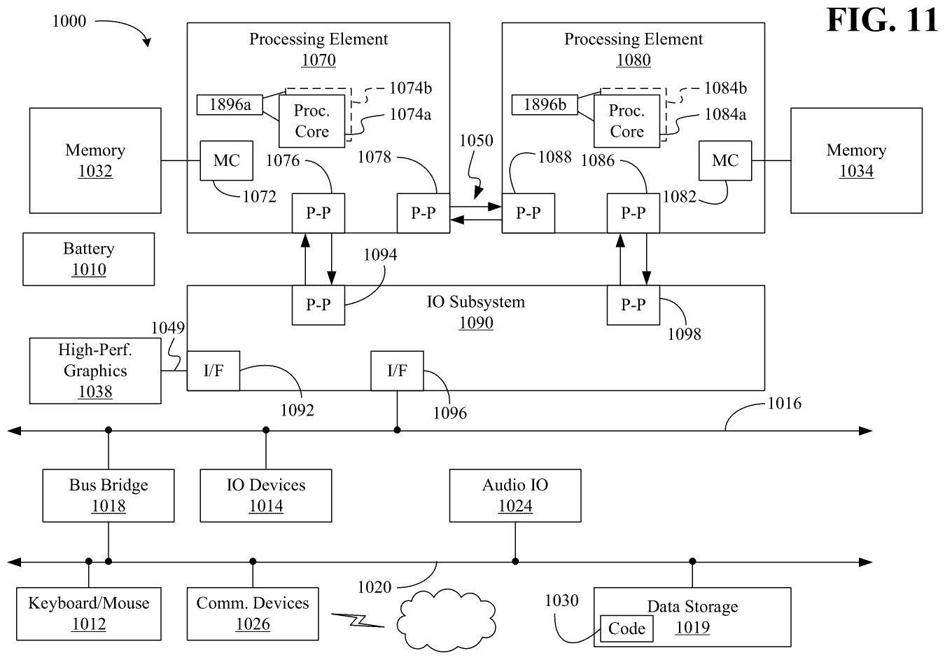

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 70 (FIG. 6) and/or the method 80 (FIG. 7), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### ADDITIONAL NOTES AND EXAMPLES

Example 1 includes a performance-enhanced computing system comprising a network controller, a processor coupled to the network controller, and a memory coupled to the processor, wherein the memory includes one or more executable program instructions, which when executed by the processor, cause the processor to determine a plurality of transient thermal responses for a corresponding plurality of power source locations on a semiconductor die, obtain corner block list (CBL) representations associated with a plurality of candidate floorplans, and conduct an artificial intelligence (AI) based search of the CBL representations, wherein an output of the AI based search is one or more suggested floorplans having a transient thermal response that is below a thermal threshold.

Example 2 includes the computing system of Example 1, wherein the one or more executable program instructions, when executed, further cause the processor to identify a plurality of blocks having a physical connectivity constraint, and combine the plurality of blocks into a group.

Example 3 includes the computing system of Example 2, wherein the one or more executable instructions, when executed, further cause the processor to conduct a rotation analysis of the group based on one or more of the plurality of transient thermal responses.

Example 4 includes the computing system of Example 3, wherein the one or more executable instructions, when executed, further cause the processor to split the group into the plurality of blocks after the rotation analysis, and conduct a symmetry analysis of the plurality of blocks based on one or more of the plurality of transient thermal responses.

Example 5 includes the computing system of any one of Examples 1 to 4, wherein the one or more executable instructions, when executed, further cause the processor to insert one or more dummy blocks into the CBL representations based on empty space data associated with the semiconductor die.

Example 6 includes at least one computer readable storage medium comprising one or more executable program instructions, which when executed by a computing system, cause the computing system to determine a plurality of transient thermal responses for a corresponding plurality of power source locations on a semiconductor die, obtain corner block list (CBL) representations associated with a plurality of candidate floorplans, and conduct an artificial intelligence (AI) based search of the CBL representations, wherein an output of the AI based search is one or more suggested floorplans having a transient thermal response that is below a thermal threshold.

Example 7 includes the at least one computer readable storage medium of Example 6, wherein the one or more executable program instructions, when executed, further cause the computing system to identify a plurality of blocks having a physical connectivity constraint, and combine the plurality of blocks into a group.

Example 8 includes the at least one computer readable storage medium of Example 7, wherein the one or more executable instructions, when executed, further cause the computing system to conduct a rotation analysis of the group based on one or more of the plurality of transient thermal responses.

Example 9 includes the at least one computer readable storage medium of Example 8, wherein the one or more executable instructions, when executed, further cause the computing system to split the group into the plurality of blocks after the rotation analysis, and conduct a symmetry analysis of the plurality of blocks based on one or more of the plurality of transient thermal responses.

Example 10 includes the at least one computer readable storage medium of Example 6, wherein the one or more executable instructions, when executed, further cause the computing system to insert one or more dummy blocks into the CBL representations based on empty space data associated with the semiconductor die.

Example 11 includes the at least one computer readable storage medium of any one of Examples 6 to 10, wherein the AI based search includes one or more simulated annealing operations.

Example 12 includes the at least one computer readable storage medium of any one of Examples 6 to 10, wherein the AI based search includes one or more reinforcement learning operations.

Example 13 includes a semiconductor apparatus comprising one or more substrates, and logic coupled to the one or more substrates, wherein the logic is implemented at least partly in one or more of configurable or fixed-functionality hardware, the logic to determine a plurality of transient thermal responses for a corresponding plurality of power source locations on a semiconductor die, obtain corner block list (CBL) representations associated with a plurality of candidate floorplans, and conduct an artificial intelligence (AI) based search of the CBL representations, wherein an output of the AI based search is one or more suggested floorplans having a transient thermal response that is below a thermal threshold.

Example 14 includes the semiconductor apparatus of Example 13, wherein the logic is further to identify a plurality of blocks having a physical connectivity constraint, and combine the plurality of blocks into a group.

Example 15 includes the semiconductor apparatus of Example 14, wherein the logic is further to conduct a rotation analysis of the group based on one or more of the plurality of transient thermal responses.

Example 16 includes the semiconductor apparatus of Example 15, wherein the logic is further to split the group into the plurality of blocks after the rotation analysis, and conduct a symmetry analysis of the plurality of blocks based on one or more of the plurality of transient thermal responses.

Example 17 includes the semiconductor apparatus of Example 13, wherein the logic is further to insert one or more dummy blocks into the CBL representations based on empty space data associated with the semiconductor die.

Example 18 includes the semiconductor apparatus of any one of Examples 13 to 17, wherein the AI based search includes one or more simulated annealing operations.

Example 19 includes the semiconductor apparatus of any one of Examples 13 to 17, wherein the AI based search includes one or more reinforcement learning operations.

Example 20 includes the semiconductor apparatus of any one of Examples 13 to 19, wherein the logic coupled to the one or more substrates includes transistor channel regions that are positioned within the one or more substrates.

Example 21 includes a method of operating a performance-enhanced computing system, the method comprising determining a plurality of transient thermal responses for a corresponding plurality of power source locations on a semiconductor die, obtaining corner block list (CBL) representations associated with a plurality of candidate floorplans, and conducting an artificial intelligence (AI) based search of the CBL representations, wherein an output of the AI based search is one or more suggested floorplans having a transient thermal response that is below a thermal threshold.

Example 22 includes an apparatus comprising means for performing the method of Example 21.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, wherein the memory includes one or more executable program instructions, which when executed by the processor, cause the processor to:
determine a plurality of transient thermal responses for a corresponding plurality of power source locations on a semiconductor die,
obtain corner block list (CBL) representations associated with a plurality of candidate floorplans, and
conduct an artificial intelligence (AI) based search of the CBL representations, wherein an output of the AI based search is one or more suggested floorplans having a transient thermal response that is below a thermal threshold.

2. The computing system of claim 1, wherein the one or more executable program instructions, when executed, further cause the processor to:
identify a plurality of blocks having a physical connectivity constraint, and
combine the plurality of blocks into a group.

3. The computing system of claim 2, wherein the one or more executable instructions, when executed, further cause the processor to conduct a rotation analysis of the group based on one or more of the plurality of transient thermal responses.

4. The computing system of claim 3, wherein the one or more executable instructions, when executed, further cause the processor to:
split the group into the plurality of blocks after the rotation analysis; and
conduct a symmetry analysis of the plurality of blocks based on one or more of the plurality of transient thermal responses.

5. The computing system of claim 1, wherein the one or more executable instructions, when executed, further cause the processor to insert one or more dummy blocks into the CBL representations based on empty space data associated with the semiconductor die.

6. At least one computer readable storage medium comprising one or more executable program instructions, which when executed by a computing system, cause the computing system to:
determine a plurality of transient thermal responses for a corresponding plurality of power source locations on a semiconductor die;
obtain corner block list (CBL) representations associated with a plurality of candidate floorplans; and
conduct an artificial intelligence (AI) based search of the CBL representations, wherein an output of the AI based search is one or more suggested floorplans having a transient thermal response that is below a thermal threshold.

7. The at least one computer readable storage medium of claim 6, wherein the one or more executable program instructions, when executed, further cause the computing system to:
identify a plurality of blocks having a physical connectivity constraint; and
combine the plurality of blocks into a group.

8. The at least one computer readable storage medium of claim 7, wherein the one or more executable instructions, when executed, further cause the computing system to conduct a rotation analysis of the group based on one or more of the plurality of transient thermal responses.

9. The at least one computer readable storage medium of claim 8, wherein the one or more executable instructions, when executed, further cause the computing system to:
split the group into the plurality of blocks after the rotation analysis; and
conduct a symmetry analysis of the plurality of blocks based on one or more of the plurality of transient thermal responses.

10. The at least one computer readable storage medium of claim 6, wherein the one or more executable instructions, when executed, further cause the computing system to insert one or more dummy blocks into the CBL representations based on empty space data associated with the semiconductor die.

11. The at least one computer readable storage medium of claim 6, wherein the AI based search includes one or more simulated annealing operations.

12. The at least one computer readable storage medium of claim 6, wherein the AI based search includes one or more reinforcement learning operations.

13. A semiconductor apparatus comprising:
one or more substrates; and
logic coupled to the one or more substrates, wherein the logic is implemented at least partly in one or more of configurable or fixed-functionality hardware, the logic to:
determine a plurality of transient thermal responses for a corresponding plurality of power source locations on a semiconductor die;
obtain corner block list (CBL) representations associated with a plurality of candidate floorplans; and
conduct an artificial intelligence (AI) based search of the CBL representations, wherein an output of the AI based search is one or more suggested floorplans having a transient thermal response that is below a thermal threshold.

14. The semiconductor apparatus of claim 13, wherein the logic is further to:
identify a plurality of blocks having a physical connectivity constraint; and
combine the plurality of blocks into a group.

15. The semiconductor apparatus of claim 14, wherein the logic is further to conduct a rotation analysis of the group based on one or more of the plurality of transient thermal responses.

16. The semiconductor apparatus of claim 15, wherein the logic is further to:
split the group into the plurality of blocks after the rotation analysis; and
conduct a symmetry analysis of the plurality of blocks based on one or more of the plurality of transient thermal responses.

17. The semiconductor apparatus of claim 13, wherein the logic is further to insert one or more dummy blocks into the CBL representations based on empty space data associated with the semiconductor die.

18. The semiconductor apparatus of claim 13, wherein the AI based search includes one or more simulated annealing operations.

19. The semiconductor apparatus of claim 13, wherein the AI based search includes one or more reinforcement learning operations.

20. The semiconductor apparatus of claim 13, wherein the logic coupled to the one or more substrates includes transistor channel regions that are positioned within the one or more substrates.
